(19) United States
(12) Patent Application Publication
(10) Pub. No.: US 2018/0188375 A1
(43) Pub. Date: Jul. 5, 2018

(54) INTELLIGENT PARKING SYSTERM AND PARKING LOT USING THE SAME

(71) Applicant: HON HAI PRECISION INDUSTRY CO., LTD., New Taipei (TW)

(72) Inventors: KUO-KUANG LIAO, New Taipei (TW); HUAN-WEN CHEN, New Taipei (TW)

(21) Appl. No.: 15/790,072

(22) Filed: Oct. 23, 2017

(30) Foreign Application Priority Data
Jan. 4, 2017 (TW) 106100185

(51) Int. Cl. G01S 17/93; G01S 19/51; H04W 4/04; G08G 1/065; G01C 21/36

(52) U.S. Cl. CPC G01S 17/936; G01S 19/51; G01C 21/3685; G08G 1/065; H04W 4/043

(57) ABSTRACT

A navigation system includes a navigation management module, a GPS navigation module, an LiDAR navigation module, an LiDAR navigation module and an environmental judgment module. The navigation management module is used to integrate and output navigation information and store map. The GPS navigation module is used to provide GPS navigation information to the navigation management module. The LiDAR navigation module is used to provide LiDAR information to the navigation management module. The environmental judgment module is used to determine whether the navigation system is indoors. The navigation management module is used to integrate and output different navigation information according to whether the navigation system is indoors.

### CROSS-REFERENCE TO RELATED APPLICATIONS

This application claims all benefits accruing under 35 U.S.C. § 119 from Taiwan Patent Application No. 106100185, filed on Jan. 4, 2017, in the Taiwan Intellectual Property Office, the contents of which are hereby incorporated by reference.

### FIELD

The subject matter herein generally relates to an intelligent parking system and parking lot using the same.

### BACKGROUND

Conventional parking lots generally use an indicator light to indicate whether the vehicle parking space parks a vehicle. When the indicator light is red, there is vehicle parked in the parking space; when the indicator light is green, there is no vehicle parked in the parking space. The indicator light is located above each parking space, depending on whether there is a large object under the indicator light to determine whether the vehicle parked in the parking space. In this kind of parking lot, a distance between the indicator light and the driver should be near enough see the indicator light, and the driver cannot know the condition of the whole parking lot to quickly find a parking space.

What is needed, therefore, is to provide an intelligent parking system and parking lot using the same which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic base module view showing an intelligent parking system provided according to embodiment of the present invention.

FIG. 2 is a 3D instant map provided by the intelligent parking system.

FIG. 3 is a plan instant map provided by the intelligent parking system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The connection can be such that the objects are permanently connected or releasable connected. The term “substantially” is defined to be essentially conforming to the particular dimension, shape or other word that substantially modifies, such that the component need not be exact. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to a intelligent parking system and a parking lot using the same described in detail as below.

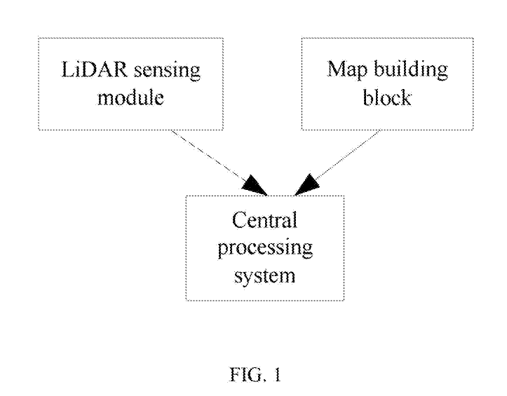

Referring to FIG. 1, an intelligent parking system according to one embodiment is provided. The intelligent parking system comprises a plurality of Light Detection and Ranging (LiDAR) sensing modules, a plurality of instant map building blocks and a central processing system. The plurality of LiDAR sensing modules, the plurality of instant map building blocks, and the central processing system are connected to each other by wireless or cable.

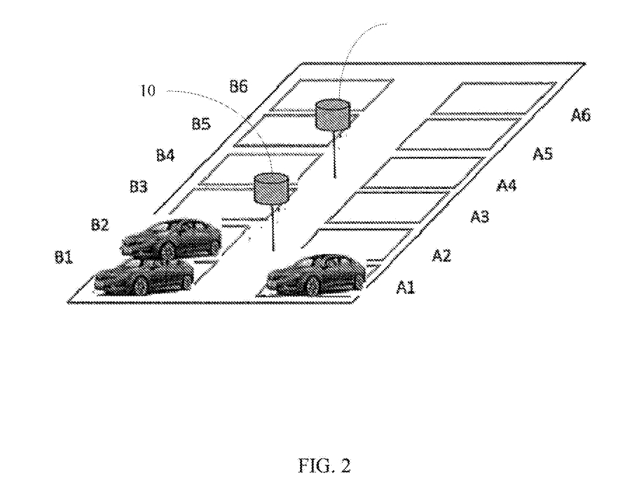

Referring to FIG. 2, the plurality of LiDAR sensing modules 10 are distributed inside a parking lot in which the intelligent parking system is applied. The plurality of LiDAR sensing modules 10 can be distributed at a top space of the parking lot. A sum of the number of LiDAR sensing modules 10 in the parking lot is related with and a size of the parking lot and an effective sensing area of each LiDAR sensing module 10. And, a sum of the effective sensing areas of the plurality of LiDAR sensing modules 10 is greater than or equal to an area of the parking lot. For example, when the area of the parking lot is 1000 m² and the effective sensing area of each LiDAR sensing module 10 is 100 m², at least 10 LiDAR sensing modules 10 should be placed in the parking lot. The plurality of LiDAR sensing modules are used to detect a vehicle getting into the parking lot and parking information in the parking lot. The plurality of LiDAR sensing modules 10 judge the position of the vehicle, whether the vehicle is traveling or not, and whether or not the vehicle is parked on a parking space.

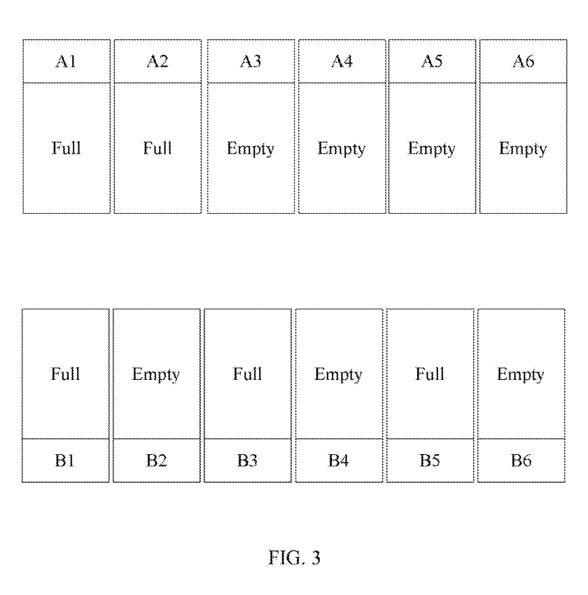

The instant map building module is used to receive signal transmitted from the LiDAR sensing module 10 and construct an instant map and then transmit the map to the central processing system. In the present embodiment, the instant map building module uses the SLAM algorithm to quickly construct an instant map. Since the LiDAR sensing module 10 is very sensitive, it is possible to quickly create a 3D instant map as shown in FIG. 2, and then to obtain the parking information as shown in FIG. 3. The instant map and the parking information are transmitted it to the central processing system.

The plurality of instant map building blocks correspond to the plurality of LiDAR sensing modules 10 in a one by one form. That is, each LiDAR sensing module 10 corresponds to one instant map building block. The plurality of LiDAR sensing modules 10 and the plurality of map building modules can be integrated in a detection device. The detection device is installed in an upper space of the parking lot.

The central processing system is used to receive the instant map and compare the instant map with a plane map of the parking lot stored in the central processing system and output a parking lot parking information to a driver in the vehicle who searches for the parking space. After driving the vehicle into the parking lot, the driver opens a car network equipment to connect a network in the parking lot. Through the network, the driver can receive the parking lot parking information transmitted from the central processor to determine which parking spaces can park the vehicle. The driver can choose a parking space to be parked, set up a navigation route, and choose a best route to reach the parking space.

When the parking lot is full, the vehicle is waiting outside the parking lot. because the LiDAR sensor module 10 of intelligent parking system has a high speed reaction, the intelligent parking system can quickly determine whether there is a vehicle leaving from the parking space, and an empty parking space is obtained. The information is passed to the driver quickly, and the driver will drive the vehicle to the empty parking space, which reduces a waiting time of the driver. In addition, the vehicle can also obtain images from the intelligent parking system, which will help the driver determine a distance between the vehicle and surrounding objects, and the driver can entry the parking space faster.

Compared with conventional intelligent parking system, the intelligent parking system provided by the invention adopts the LiDAR sensor module to construct the instant map of the parking lot and quickly compares the instant map with the parking map stored in the central processing system, and then transmits the information to the driver. As such, the driver can be obtain information of the whole parking lot at the first time, and can quickly find a parking space.

A parking lot according to one embodiment is provided. The parking lot uses the intelligent parking system discussed above. The parking lot comprises: a plurality of detectors, each detector comprises a LiDAR sensing module and an instant map building blocks, the LiDAR sensing module and the instant map building block are used to map an instant map of the parking lot; and a central processing system, the central processing system is used to receive the instant map, compare the instant map with a parking map stored in the central processing system to get a parking information, and transmit the parking information to a driver in a vehicle getting into the parking lot.

The plurality of detectors may be distributed at a top of the parking lot. The number of detectors in the parking lot and the size of the parking lot are related to the effective sensing area of the detector, and the sum of the effective sensing areas of the multiple detectors is greater than or equal to the area of the parking lot.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. An intelligent parking system comprising:
a plurality of Light Detection and Ranging (LiDAR) sensing modules configured to detect a vehicle getting into a parking lot and parking information in the parking lot;
a plurality of instant map building blocks configured to receive parking information transmitted from the plurality of LiDAR sensing modules and construct an instant map; and
a central processing system configured to receive the instant map, compare the instant map with a map of the parking lot stored in the central processing system and output the parking information of the parking lot to a driver in the vehicle.

2. The system of claim 1, wherein the plurality of LiDAR sensing modules are distributed inside the parking lot.

3. The system of claim 2, wherein the plurality of LiDAR sensing modules are distributed at a top space of the parking lot.

4. The system of claim 1, wherein the a sum of effective sensing areas of the plurality of LiDAR sensing modules is greater than or equal to an area of the parking lot.

5. The system of claim 1, wherein the plurality of LiDAR sensing modules are configured to judge the position of the vehicle, whether the vehicle is traveling or not, and whether or not the vehicle is parked on a parking space.

6. The system of claim 1, wherein the instant map building module uses a SLAM algorithm to construct the instant map.

7. The system of claim 1, wherein the plurality of instant map building blocks correspond to the plurality of LiDAR sensing modules in a one by one manner.

8. The system of claim 1, wherein each of the plurality of LiDAR sensing modules and each of the plurality of map building modules is integrated in a detection device.

9. The system of claim 8, wherein the detection device is installed in an upper space of the parking lot.

10. The system of claim 1, wherein after driving the vehicle into the parking lot, the driver opens a vehicle network equipment to connect a network in the parking lot and receive parking information form the intelligent parking system.

12. A parking lot comprising:
a plurality of detectors, wherein each detector comprises a LiDAR sensing module and an instant map building blocks, the LiDAR sensing module is configured to detect a vehicle getting into the parking lot and parking information in the parking lot, and the instant map building block is configured to map an instant map of the parking lot; and
a central processing system, wherein the central processing system is configured to receive the instant map, compare the instant map with a parking map stored in the central processing system to get a parking information, and transmit the parking information to a driver in a vehicle getting into the parking lot.

13. The parking lot of claim 12, wherein the plurality of detectors are distributed at a top of the parking lot.

14. The parking lot of claim 12, wherein a sum of the effective sensing areas of the plurality of detectors is greater than or equal to the area of the parking lot.
